(19) United States
(12) Patent Application Publication
(10) Pub. No.: US 2023/0307805 A1
(43) Pub. Date: Sep. 28, 2023

(54) STANDOFF ASSEMBLIES FOR TRACTION BATTERY PACKS WITH CELL-TO-PACK BATTERY SYSTEMS

(71) Applicant: FORD GLOBAL TECHNOLOGIES, LLC, Dearborn, MI (US)

(72) Inventor: Patrick Daniel MAGUIRE, Ann Arbor, MI (US)

(21) Appl. No.: 17/895,361

(22) Filed: Aug. 25, 2022

Related U.S. Application Data
(60) Provisional application No. 63/322,766, filed on Mar. 23, 2022.

(51) Int. Cl. H01M 50/591; H01M 50/209; H01M 50/291; H01M 50/271; H01M 50/293; H01M 50/588

(52) U.S. Cl. CPC H01M 50/591; H01M 50/209; H01M 50/291; H01M 50/271; H01M 50/293; H01M 50/588; H01M 2220/20

(57) ABSTRACT

Standoff assemblies are disclosed for use within traction battery packs that include cell-to-pack battery systems. One or more standoff assemblies may be arranged between a cell-to-pack battery system and an enclosure cover of the traction battery pack. The standoff assemblies are configured to maintain a spaced relationship between the enclosure cover and certain components (e.g., battery cells, bus bars, etc.) of the cell-to-pack battery system.

### CROSS-REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs, and more particularly to standoff assemblies for maintaining a spaced relationship between an enclosure cover and components of a cell-to-pack battery system.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly including an enclosure cover and an enclosure tray, a battery system housed within the enclosure assembly, and a standoff assembly arranged between the enclosure cover and the battery system.

In a further non-limiting embodiment of the foregoing traction battery pack, the standoff assembly is positioned between the enclosure cover and a cell stack of the battery system.

In a further non-limiting embodiment of either of the foregoing traction battery packs, the standoff assembly maintains a gap between an interior surface of the enclosure cover and a top surface of a battery cell of the cell stack.

In a further non-limiting embodiment of any of the foregoing traction battery packs, the battery system is a cell-to-pack battery system, and the enclosure tray provides a cell-compressing opening for compressing a cell matrix of the cell-to-pack battery system.

In a further non-limiting embodiment of any of the foregoing traction battery packs, the standoff assembly is a polymer-based component.

In a further non-limiting embodiment of any of the foregoing traction battery packs, the standoff assembly includes a standoff having a lower section and an upper section that protrudes upwardly from the lower structure.

In a further non-limiting embodiment of any of the foregoing traction battery packs, the lower section is received against a top surface of a battery cell of the battery system, and the upper section is arranged over a bus bar that is connected to the battery cell.

In a further non-limiting embodiment of any of the foregoing traction battery packs, the upper section establishes a canopy over the bus bar.

In a further non-limiting embodiment of any of the foregoing traction battery packs, the canopy is connected to the lower section by a connector.

In a further non-limiting embodiment of any of the foregoing traction battery packs, the canopy is rectangular-shaped.

In a further non-limiting embodiment of any of the foregoing traction battery packs, the canopy is cylindrical-shaped.

In a further non-limiting embodiment of any of the foregoing traction battery packs, the standoff assembly includes a first standoff section having a first plurality of standoffs, a second standoff section having a second plurality of standoffs, and a plurality of struts that connect between the first standoff section and the second standoff section.

A traction battery pack according to another exemplary aspect of the present disclosure includes, among other things, an enclosure assembly including an enclosure cover and an enclosure tray, a cell-to-pack battery system housed within the enclosure assembly and including a first cell stack, and a standoff assembly arranged to maintain a spaced relationship between the enclosure cover and the first cell stack.

In a further non-limiting embodiment of the foregoing traction battery pack, the standoff assembly is a polymer-based component.

In a further non-limiting embodiment of either of the foregoing traction battery packs, the standoff assembly includes a first standoff section having a first plurality of standoffs, a second standoff section having a second plurality of standoffs, and a plurality of struts that connect between the first standoff section and the second standoff section.

In a further non-limiting embodiment of any of the foregoing traction battery packs, the first standoff section is arranged to extend along a first longitudinal edge of the first cell stack, and the second standoff section is arranged to extend along a second longitudinal edge of the first cell stack.

In a further non-limiting embodiment of any of the foregoing traction battery packs, a first strut of the plurality of struts is at least partially received within a seam between a first battery cell and a second battery cell of the first cell stack.

In a further non-limiting embodiment of any of the foregoing traction battery packs, the standoff assembly includes a standoff having a lower section and an upper section that protrudes upwardly from the lower structure.

In a further non-limiting embodiment of any of the foregoing traction battery packs, the lower section is received against a top surface of a battery cell of the first cell stack, and the upper section is arranged over a bus bar that is connected to the battery cell.

In a further non-limiting embodiment of any of the foregoing traction battery packs, the upper section establishes a canopy that at least partially surrounds the bus bar.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 illustrates an exemplary standoff assembly positioned relative to a cells tack of a cell-to-pack battery system.

FIG. 5 is an exploded view of select portions of the arrangement shown in FIG. 4.

FIG. 6 is a top view of select portions of the arrangement shown in FIG. 4.

FIG. 7 illustrates portions of a traction battery pack that includes a plurality of standoff assemblies positioned over a cell matrix of a cell-to-pack battery system.

FIG. 8 illustrates an interface between standoff assemblies and an enclosure cover of a traction battery pack having a cell-to-pack battery system.

FIG. 9 illustrates another exemplary standoff assembly for use within a traction battery pack having a cell-to-pack battery system.

FIGS. 10 and 11 illustrate yet another exemplary standoff assembly for a traction battery pack having a cell-to-pack battery system.

### DETAILED DESCRIPTION

This disclosure details standoff assemblies for traction battery packs that include cell-to-pack battery systems. One or more standoff assemblies may be arranged between a cell-to-pack battery system and an enclosure cover of the traction battery pack. The standoff assemblies are configured to maintain a spaced relationship between the enclosure cover and certain components (e.g., battery cells, bus bars, etc.) of the cell-to-pack battery system. These and other features are discussed in greater detail in the following paragraphs of this detailed description.

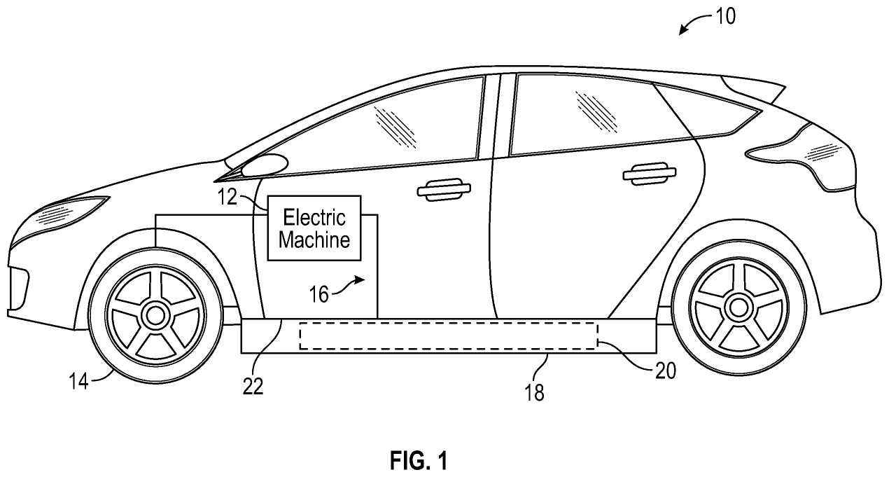

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

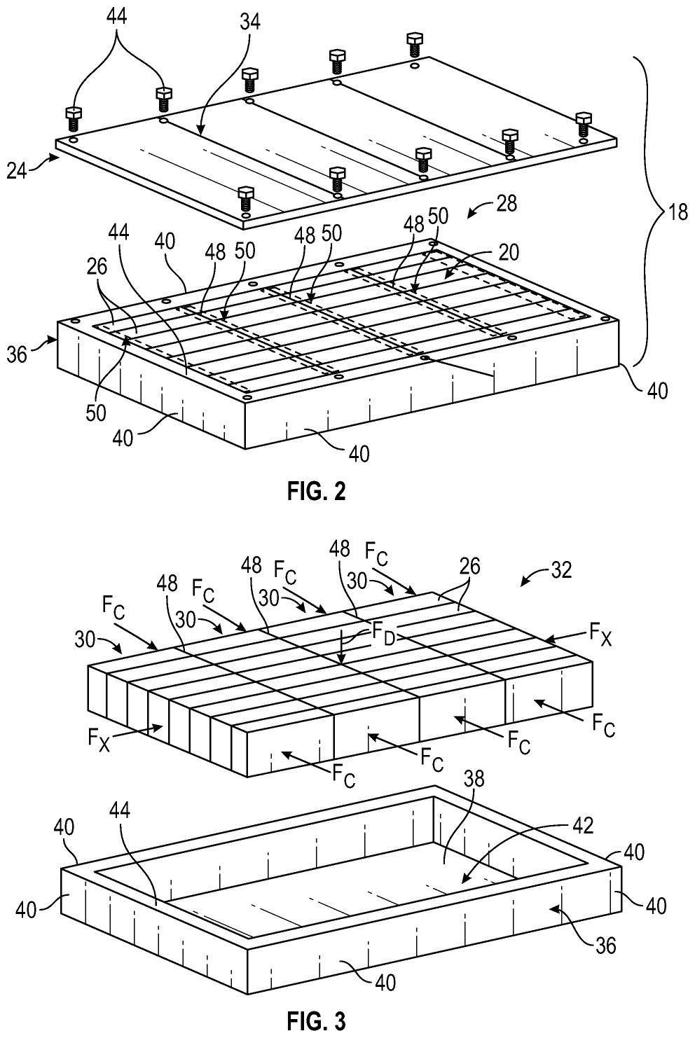

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force F_{C} may be applied to opposed ends of one of the cell stacks 30. The compressive force F_{C} essentially squeezes the battery cells 26 within the cell stack 30, thereby compressing the cell stack 30 and the individual battery cells 26 to a reduced thickness. While the compressive force F_{C} is applied to the cell stack 30, the cell stack 30 may be inserted into a respective cell-compressing opening 42 by a downward force F_{D}. The downward force F_{D} may be applied directly to one or more of the battery cells 26.

While the term “downward” is used herein to describe the downward force F_{D}, it should be understood that the term “downward” is used herein to refer to all forces tending to press a cell stack 30 into a cell compressing opening 42. In particular, the term “downward” refers to all forces substantially perpendicular to the compressive force F_{C}, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional compressive forces F_{X} can compress the cell stacks 30 together for insertion of the cell matrix 32 into the cell-compressing opening 42. The compressive forces F_{X} are generally perpendicular to the compressive forces F_{C}. The compressive forces F_{X} may be applied together with the compressive forces F_{C}. The force F_{D} may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure.

The traction battery pack 18 may further include one or more standoff assemblies 50. In an embodiment, one standoff assembly 50 is positioned between the enclosure cover 34 and each cell stack 30 of the cell matrix 32 (schematically shown in FIG. 2). However, the total number of standoff assemblies 50 provided within the traction battery pack 18 is not intended to limit this disclosure.

As further detailed below, the standoff assemblies 50 may provide various functions and advantages to the traction battery pack 18, including but not limited to maintaining a spaced relationship between the enclosure cover 34 and the cells stacks 30 of the cell-to-pack battery system 20, distributing loads imparted through the enclosure cover 34 across the cell matrix 32, increasing rigidity/stiffness of the cover-to-cell matrix construct, providing cell stack locating features, etc. The functionality provided by the standoff assemblies 50 described herein may be particularly beneficial for traction battery packs that include cell-to-pack type battery systems because the array support structures traditionally provided within battery arrays has been largely eliminated from the cell-to-pack battery system 20, and the rigid cross members traditionally provided for distributing loads imparted on the enclosure cover 34 have been eliminated from the enclosure tray 36.

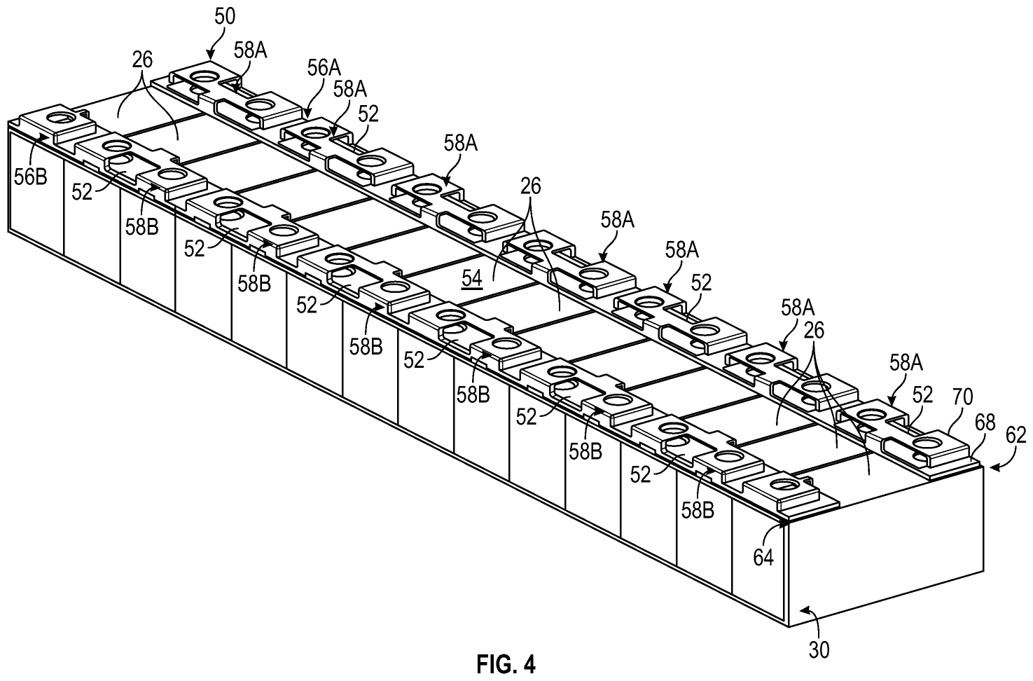

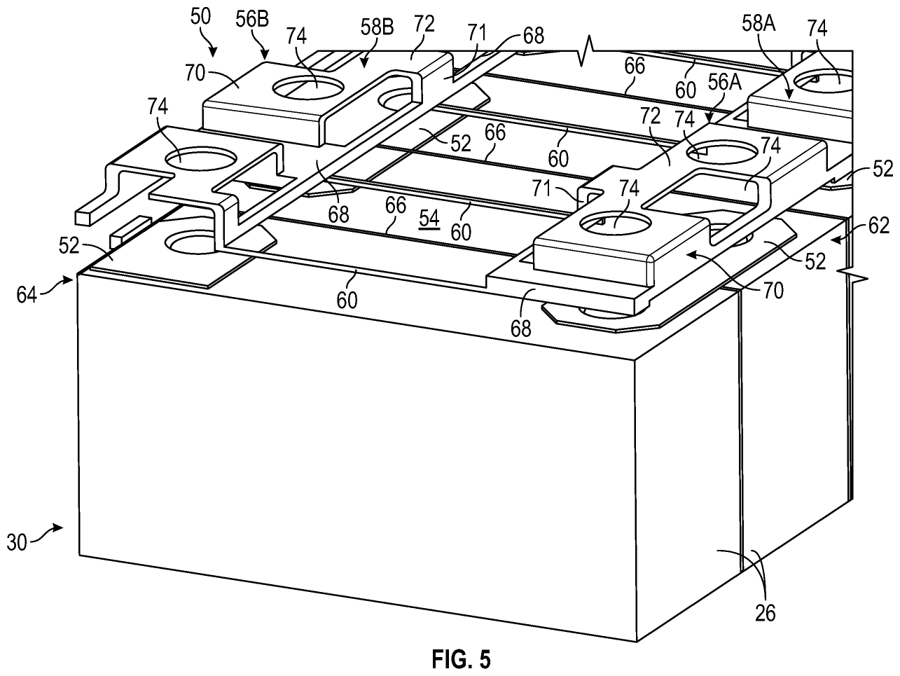

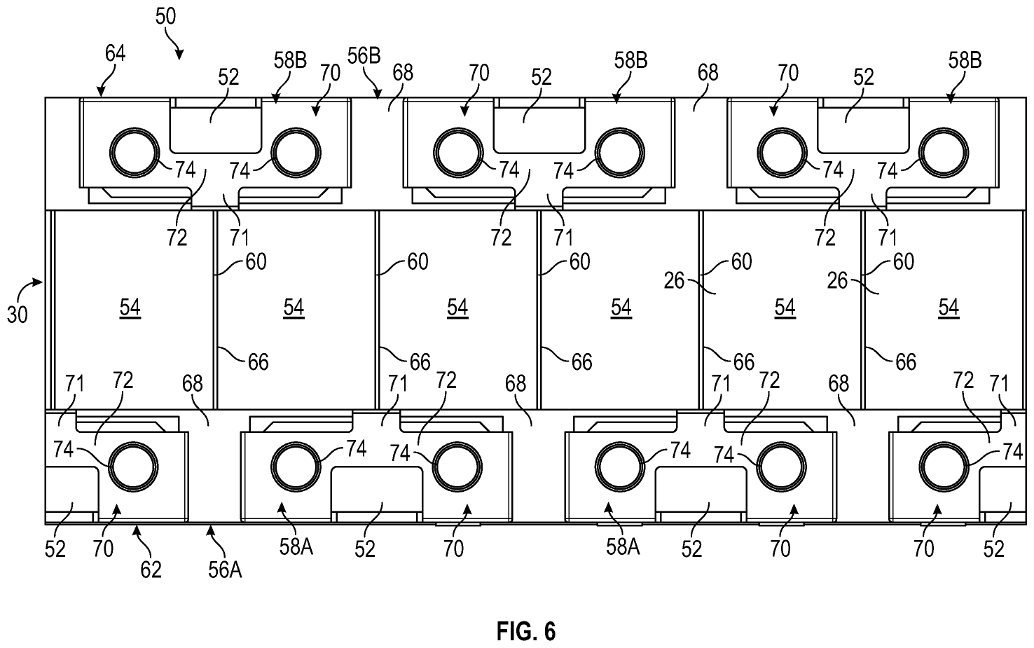

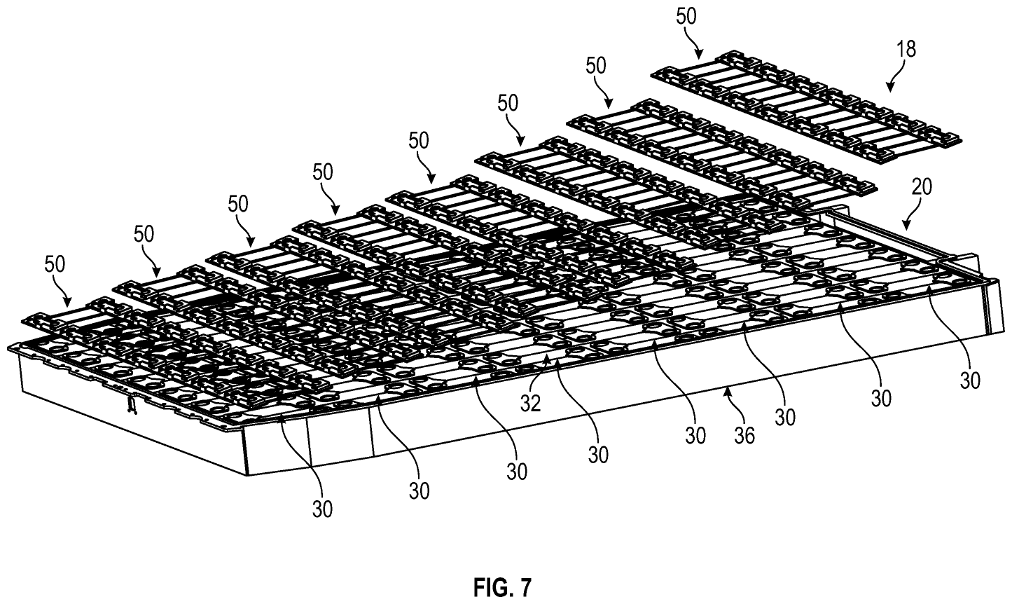

FIGS. 4, 5, and 6, with continued reference to FIGS. 1-3, illustrate an exemplary design of a standoff assembly 50 that may be used within the traction battery pack 18. These figures specifically illustrate one standoff assembly 50 positioned over top of one cell stack 30 of a cell-to-pack battery system. However, as mentioned above, a plurality of standoff assemblies 50 could be positioned over top of a cell matrix 32 of a cell-to-pack battery system 20 (see, e.g., FIG. 7).

The cell stack 30 may include a plurality of battery cells 26 that are stacked relative to one another. The battery cells 26 of the cell stack 30 may be electrically connected to one another by a plurality of bus bars 52. Each bus bar 52 may be attached (e.g., welded) at a top surface 54 of one or more of the battery cells 26.

The standoff assembly 50 may include a first standoff section 56A having a first plurality of standoffs 58A, a second standoff section 56B having a second plurality of standoffs 58B, and a plurality of struts 60 that connect between the first standoff section 56A and the second standoff section 56B. Together, the first standoff section 56A, the second standoff section 56B, and the struts 60 may establish a unitary, single-piece structure of the standoff assembly 50.

The standoff assembly 50 may be arranged over top of the cell stack 30 so as to contact the top surfaces 54 of the battery cells 26. When positioned over the cell stack 30, the first standoff section 56A may be aligned with and extend along a first longitudinal edge 62 of the cell stack 30, and the second standoff section 56B may be aligned with and extend along a second longitudinal edge 64 of the cell stack 30. In addition, the struts 60 may be at least partially received within seams 66 that extend between adjacent battery cells 26 when the standoff assembly 50 is positioned in place over the cell stack 30.

Each of the first and second plurality of standoffs 58A, 58B may include a lower structure 68 and an upper structure 70 that protrudes upwardly from the lower structure 68. When the standoff assembly 50 is positioned over the cell stack 30, the lower structure 68 may be received against the top surface 54 of one or more battery cells 26, and the upper structure 70 may be positioned over one of the bus bars 52.

The upper structures 70 may establish a canopy 72 that extends directly over top of the bus bars 52. The canopies 72 may be connected to the lower structure 68 by one or more connectors 71. Each canopy 72 may be sized and shaped to accommodate a corresponding size and shape of the bus bars 52. Each canopy 72 may further include one or more openings 74 for establishing electrical connections with the bus bars 52. The canopies 72 may provide a “finger-proof” mechanism for preventing inadvertent exposure to the bus bars 52 and/or the battery cells 26.

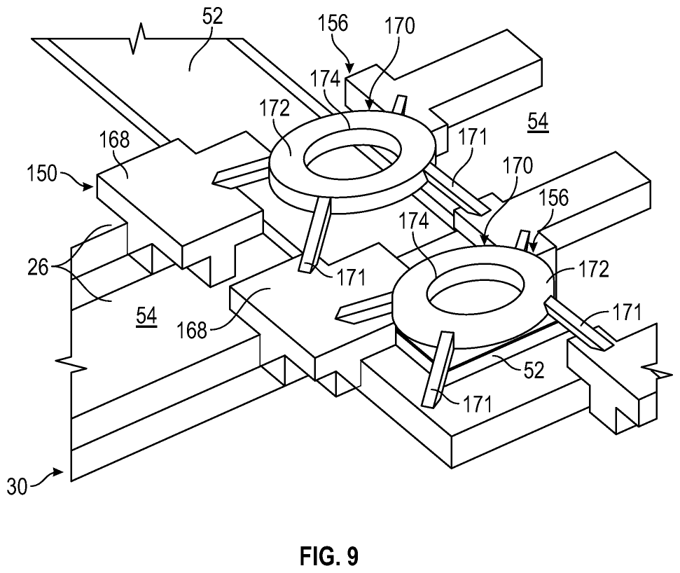

In an embodiment, the canopies 72 of the upper structures 70 are generally rectangular-shaped structures. However, other geometric patterns are further contemplated within the scope of this disclosure (see, e.g., FIG. 9).

The standoff assembly 50 may be a polymer-based component. For example, the standoff assembly 50 could be constructed out of a sheet moulding compound (e.g., glass-fiber reinforced polyester), polypropylene, polyamide, etc.

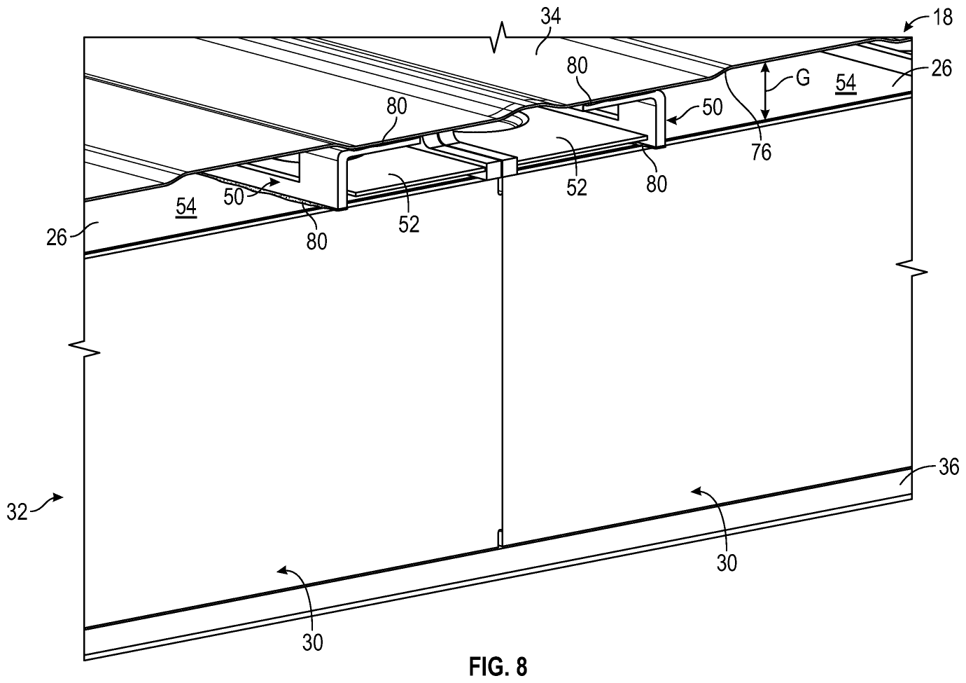

Referring now primarily to FIG. 8, with continued reference to FIGS. 1-6, the one or more standoff assemblies 50 of the traction battery pack 18 may maintain a spaced relationship between the enclosure cover 34 and the cell matrix 32 of the cell-to-pack battery system 20. Therefore, a gap G may be maintained between an interior surface 76 of the enclosure cover 34 and the cell matrix 32 even when loads are being applied to the enclosure cover 34. The standoff assemblies 50 may thus prevent the enclosure cover 34 from contacting components, such as the battery cells 26 and the bus bars 52, when it flexes, thereby substantially preventing short circuit conditions.

The standoff assemblies 50 may be secured to both the enclosure cover 34 and the underlying cell stack 30 to increase the stiffness across the construct. In an embodiment, each standoff assembly 50 may be secured to the cell stack 30/cell matrix 32 using a structural adhesive 80. The structural adhesive 80 may be an epoxy, a double sided tape with pressure sensitive adhesive, or any other suitable adhesive. The structural adhesive may be applied both between the interior surface 76 of the enclosure cover 34 and the canopy 72 of each standoff 58 of the standoff assembly 50 and between the lower structure 68 of each standoff 58 and the cell stack 30/cell matrix 32.

FIG. 9 illustrates another exemplary standoff assembly 150 for spacing an enclosure cover (not shown) from a cell stack 30 of a cell-to-pack battery system. In this embodiment, the standoff assembly 150 may include one or more interconnected standoff sections 156. Each standoff section 156 may include a lower structure 168 and an upper structure 170 that protrudes upwardly from the lower structure 168. When the standoff assembly 150 is positioned over the cell stack 30, the lower structure 168 may be received against a top surface 54 of one or more battery cells 26, and the upper structure 170 may be positioned over one or more of the bus bars 52.

The upper structures 170 may establish a canopy 172 that extends directly over top of the bus bars 52. The canopy 172 may be connected to the lower section 168 by one or more connectors 171. Each canopy 172 may be sized and shaped to accommodate a corresponding size and shape of the bus bars 52. Each canopy 172 may further include one or more openings 174 for establishing any necessary electrical connections with the bus bars 52. In this embodiment, the canopies 172 are generally cylindrical-shaped structures.

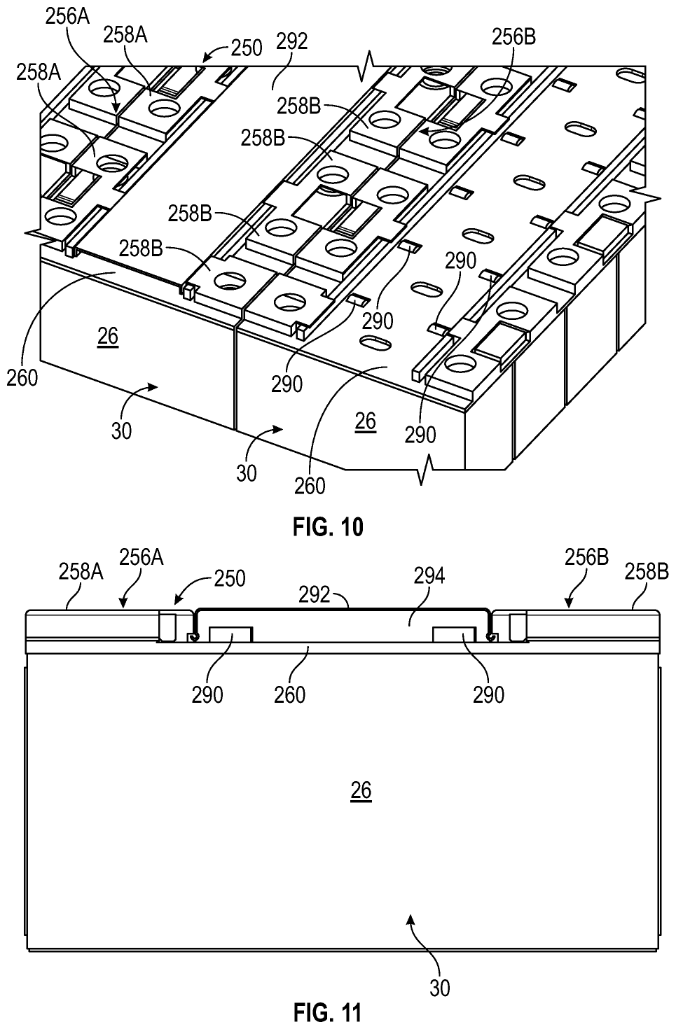

FIGS. 10 and 11 illustrate yet another exemplary standoff assembly 250 for spacing an enclosure cover (not shown) from a cell stack 30 of a cell-to-pack battery system. In this embodiment, the standoff assembly 250 may include a first standoff section 256A having a first plurality of standoffs 258A, a second standoff section 256B having a second plurality of standoffs 258B, and one or more struts 260 that connect between the first standoff section 256A and the second standoff section 256B. Together, the first standoff section 256A, the second standoff section 256B, and the strut 260 may establish a unitary, single-piece structure of the standoff assembly 250.

The standoff assembly 250 may be secured to the cell stack 30 by a plurality of clips 290. The clips 290 may be integral features of either the battery cells 26 of the cell stack 30 or of battery cell spacers that extends between adjacent battery cells 26 of the cell stack 30.

The standoff assembly 250 may further include a metallic hood structure 292. The metallic hood structure 292 may be connected to both the first standoff section 256A and the second standoff section 256B and may be located over top of the strut 260 in its mounted position. The metallic hood structure 292 may establish a vent channel 294 (see FIG. 11) for providing a heat path through the cell stack 30 for venting gases.

The exemplary standoff assemblies of this disclosure provide a gapped interface between an enclosure cover and a cell matrix of a cell-to-pack battery system. The standoff assemblies may better distribute loads imparted through the enclosure cover and substantially prevent short circuit conditions in response to such loads.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure cover and an enclosure tray;
a battery system housed within the enclosure assembly; and
a standoff assembly arranged between the enclosure cover and the battery system.

2. The traction battery pack as recited in claim 1, wherein the standoff assembly is positioned between the enclosure cover and a cell stack of the battery system.

3. The traction battery pack as recited in claim 1, wherein the standoff assembly maintains a gap between an interior surface of the enclosure cover and a top surface of a battery cell of the cell stack.

4. The traction battery pack as recited in claim 1, wherein the battery system is a cell-to-pack battery system, and further wherein the enclosure tray provides a cell-compressing opening for compressing a cell matrix of the cell-to-pack battery system.

5. The traction battery pack as recited in claim 1, wherein the standoff assembly is a polymer-based component.

6. The traction battery pack as recited in claim 1, wherein the standoff assembly includes a standoff having a lower section and an upper section that protrudes upwardly from the lower structure.

7. The traction battery pack as recited in claim 6, wherein the lower section is received against a top surface of a battery cell of the battery system, and the upper section is arranged over a bus bar that is connected to the battery cell.

8. The traction battery pack as recited in claim 7, wherein the upper section establishes a canopy over the bus bar.

9. The traction battery pack as recited in claim 8, wherein the canopy is connected to the lower section by a connector.

10. The traction battery pack as recited in claim 8, wherein the canopy is rectangular-shaped.

11. The traction battery pack as recited in claim 8, wherein the canopy is cylindrical-shaped.

12. The traction battery pack as recited in claim 1, wherein the standoff assembly includes a first standoff section having a first plurality of standoffs, a second standoff section having a second plurality of standoffs, and a plurality of struts that connect between the first standoff section and the second standoff section.

13. A traction battery pack, comprising:
an enclosure assembly including an enclosure cover and an enclosure tray;
a cell-to-pack battery system housed within the enclosure assembly and including a first cell stack; and
a standoff assembly arranged to maintain a spaced relationship between the enclosure cover and the first cell stack.

14. The traction battery pack as recited in claim 13, wherein the standoff assembly is a polymer-based component.

15. The traction battery pack as recited in claim 13, wherein the standoff assembly includes a first standoff section having a first plurality of standoffs, a second standoff section having a second plurality of standoffs, and a plurality of struts that connect between the first standoff section and the second standoff section.

16. The traction battery pack as recited in claim 15, wherein the first standoff section is arranged to extend along a first longitudinal edge of the first cell stack, and the second standoff section is arranged to extend along a second longitudinal edge of the first cell stack.

17. The traction battery pack as recited in claim 15, wherein a first strut of the plurality of struts is at least partially received within a seam between a first battery cell and a second battery cell of the first cell stack.

18. The traction battery pack as recited in claim 13, wherein the standoff assembly includes a standoff having a lower section and an upper section that protrudes upwardly from the lower structure.

19. The traction battery pack as recited in claim 18, wherein the lower section is received against a top surface of a battery cell of the first cell stack, and the upper section is arranged over a bus bar that is connected to the battery cell.

20. The traction battery pack as recited in claim 19, wherein the upper section establishes a canopy that at least partially surrounds the bus bar.
